(19) United States
(12) Patent Application Publication
(10) Pub. No.: US 2026/0158808 A1
(43) Pub. Date: Jun. 11, 2026

(54) METHOD FOR PRINTING LAYERS OF INK AND A PRINTER THEREFOR

(71) Applicant: Canon Production Printing Holding B.V., Venlo (NL)

(72) Inventors: Sina GERAN MALEK KHEYLI, Venlo (NL); Clemens T. WEIJKAMP, Venlo (NL); Tim R. FRIJNTS, Venlo (NL)

(73) Assignee: Canon Production Printing Holding B.V., Venlo (NL)

(21) Appl. No.: 19/406,593

(22) Filed: Dec. 2, 2025

(30) Foreign Application Priority Data
Dec. 10, 2024 (EP) 24218847.2

(51) Int. Cl. B41M 3/00; B41J 2/21; B41J 3/28; B41J 11/00; B41M 7/00

(52) U.S. Cl. CPC B41M 3/008; B41J 2/2117; B41J 3/28; B41J 11/00214; B41J 11/008; B41M 7/0081

(57) ABSTRACT

A method for a UV curable printer comprising a medium support surface for supporting the print media, a print head assembly for ejecting droplets of structure ink, white ink and colored ink forming a relief print on the print media and a print controller for controlling the printing of the relief print in layers, each layer to be deposited in a predetermined plurality of passes of the print head assembly over the medium support surface. The print controller receives a print job comprising a color image with color information per pixel comprising a color per pixel which is intended to be achieved by depositing the colored ink, and a height image with height information per pixel comprising a height per pixel which is intended to be achieved by depositing a plurality of elevation layers of structure ink. The print controller determines besides the plurality of elevation layers at least one reflective layer of white ink and at least colored layer of colored ink to form the color image. The print head assembly subsequently printing the plurality of elevation layers, the at least one white layer and the at least one color layer. The print controller creates a last in time elevation layer intended to be printed in the predetermined plurality of passes, wherein the last in time elevation layer is formed by droplets of structure ink having a fixed coverage per pixel in a last pass of the last in time elevation layer.

### BACKGROUND OF THE INVENTION

### 1. Field of the invention

The present invention relates to a method for a UV curable printer comprising a medium support surface for supporting the print media, a print head assembly for ejecting droplets of structure ink, white ink and colored ink forming a relief print on the print media and a print controller for controlling the printing of the relief print in layers, each layer to be deposited in a predetermined plurality of passes of the print head assembly over the medium support surface, the method comprising the steps of the print controller receiving a print job comprising a color image with color information per pixel comprising a color per pixel which is intended to be achieved by depositing the colored ink, and a height image with height information per pixel comprising a height per pixel which is intended to be achieved by depositing a plurality of elevation layers of structure ink, the print controller determining besides the plurality of elevation layers at least one reflective layer of white ink and at least colored layer of colored ink to form the color image, and the print head assembly subsequently printing the plurality of elevation layers, the at least one white layer and the at least one color layer. The predetermined number of passes depends on a selected print mode of the printer.

### 2. Description of Background Art

Elevated printing also known as 2.5D printing is known to create relief prints. Structure ink is used to build the elevation in a 2.5D print. Structure ink can be a transparent ink but also other inks such as color inks and/or varnish can be used as a structure ink.

Before putting the color on top of the layers of structure ink, extra layers are also printed to obtain a good print quality, i.e. at least one white layer and anti-contouring layers as shown in FIG. 3. One of the artifacts in elevated printing is contouring and one of the above-mentioned layers is an anti-contouring layer to tackle said problem. The anti-contouring layer is added before the elevation is built up for example to filter out a gloss-matt difference. However, adding the extra layers reduces the productivity. One of the types of contouring artifacts comes from the gloss-mat difference between coordinates of the print image that have differently built up with structure ink. An ink height on one of the two coordinates may be created by high ink coverage per pass, resulting in a gloss look and an ink height on the other one of the two coordinates is created by low ink coverage per pass, resulting in a matt look.

### SUMMARY OF THE INVENTION

It is an object of the invention to provide a method to create relief prints with as few layers as possible and without or less contouring artefacts and gloss differences.

In accordance with the present invention, the method comprises the steps of the print controller creating a last in time elevation layer intended to be printed in the predetermined plurality of passes, wherein the last in time elevation layer is formed by droplets of structure ink having a fixed coverage per pixel in at least one last pass of the last in time elevation layer. In an embodiment the fixed coverage per pixel is realized in the last one, two, three or four passes of the last in time elevation layer.

By doing so, the anti-gloss layer is left out of the layers to be printed.

According to an embodiment the method is applied to the last in time elevation layer and the one layer before the last in time elevation layer to be deposited.

According to an embodiment the method comprises the steps of the print controller receiving the print job comprising a gloss image with gloss information per pixel of the color image, and the print head assembly depositing varnish ink on top of the colored ink in accordance with the gloss image.

The present invention also relates to a UV curable printer comprising a medium support surface for supporting print media to be printed upon, a print head assembly for ejecting color inks, white ink, structure ink forming a relief print on the print media and a print controller for controlling the printing of a color image on the print media in multiple layers as to form the relief print, wherein the print controller is configured to perform the steps of a method according to the present invention.

According to an embodiment the print head assembly is configured to deposit varnish ink on top of deposited colored ink.

The present invention also relates to a non-transitory software medium comprising executable program code configured to, when executed on a print controller of a UV curable printer, enable the print controller to perform the steps of the method according to the present invention.

Further scope of applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention will become more fully understood from the detailed description given herein below and the accompanying drawings which are given by way of illustration only, and thus are not limitative of the present invention, and wherein:

FIG. 1 is a schematic perspective view of a UV curable printer;

FIG. 2A is a schematic diagram of a building up of layers according to the prior art;

FIG. 2B is a schematic diagram of a building up of layers according to the present invention;

FIG. 3 is a schematic diagram of the layers according to the prior art;

FIG. 4A is a schematic drawing of layers and passes according to the prior art;

FIG. 4B is a schematic drawing of layers and passes according to an embodiment of the method according to the present invention;

FIG. 5 is a schematic flow diagram of the method according an embodiment of the present invention; and

FIG. 6 is a schematic drawing of the recording medium according to the present invention.

### DETAILED DESCRIPTION OF THE PREFERRED EMBODIMENTS

The present invention will now be described with reference to the accompanying drawings, wherein the same reference numerals have been used to identify the same or similar elements throughout the several views.

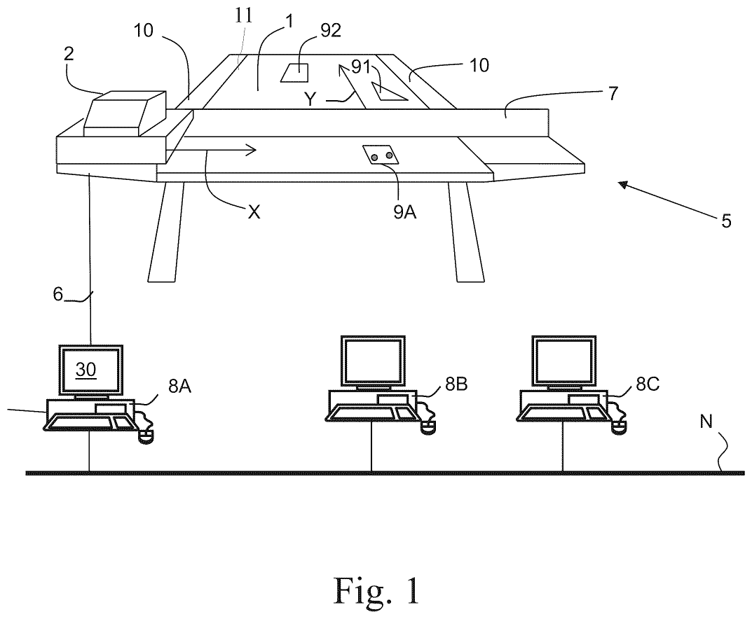

FIG. 1 is a UV curable printer 5 comprising a number of workstations 8B, 8C, which may be personal computers or other devices for preparing image data for prints to be printed. These workstations have access to a digital network N for transferring print jobs comprising the image data to a print controller 8A that is configured to receive the print jobs for prints and derive pass images. The print controller 8A may be part of the printer 5 connected to a control unit of the printer 5 via a connection 6. The printer 5 further comprises a print head assembly 2 attached to an armature 7 for applying UV curable colorants, for example cyan (C), magenta (M), yellow (Y), black (K) and white (W) colorant, and optionally varnish ink to pieces 9, 9A of print media placed on a flatbed surface 1 in order to obtain a relief print. The armature 7 may comprise a gantry above the flatbed surface 1 as shown in FIG. 1 or a robot arm (not shown) moving in a plurality of directions over the flat bed surface 1. The flatbed surface 1 is at least partially reachable by the print head assembly 2. The pieces of media may be so small that they are completely placed on the flatbed surface 1, but a piece of media which is larger than the medium support surface, in which case an image which is going to cover the whole piece of media must be printed into a plurality of parts of the image, is not excluded. A first piece 9A has already been printed upon, while the other pieces 91, 92 are not provided with any recording material yet. The print head assembly 2 reciprocally scans the flat bed surface 1 in the second direction X along a gantry 7 perpendicular to a first direction Y of the gantry 7 over the flat bed surface 1 along guiding parts 10. During printing of an image on the piece 91, 92, 9A of media may not be moved on the flat bed surface 1. This way of working is advantageous for rigid print media. A print head which is as wide as the medium support surface may also be envisaged within the scope of the invention. Such a print head may be moveable relatively to the print media in at least one direction over the flat bed surface 1.

The flatbed surface 1 comprises a medium support surface 11. The medium support surface 11 is provided with through-holes to allow air to pass through the medium support surface 11. A pressure chamber (not shown) is provided below medium support surface 11 as part of a suction chamber assembly. By applying a negative pressure in the pressure chamber, print media can be securely and flatly held against the medium support surface 11.

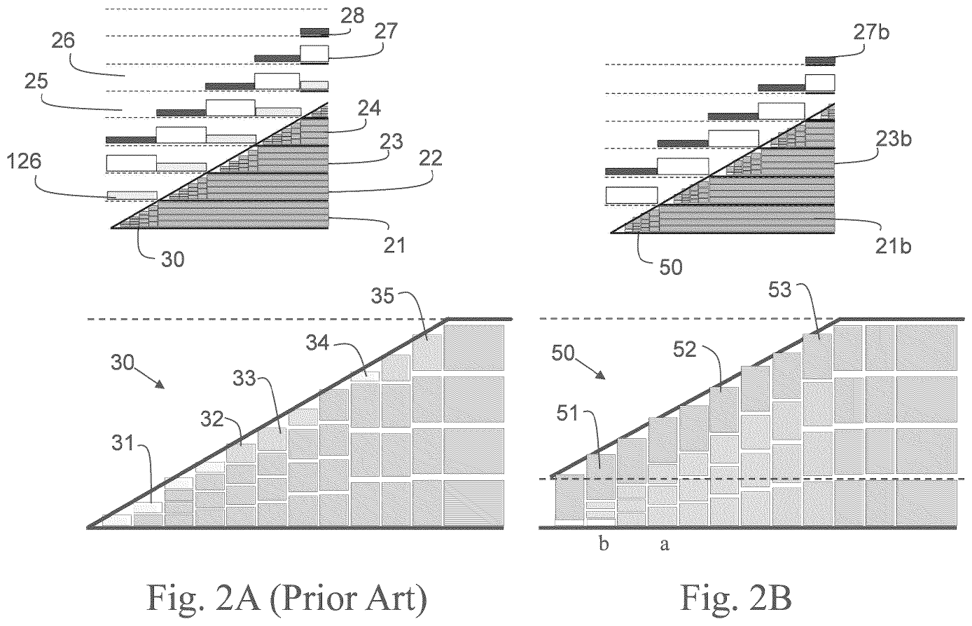

FIG. 2A is a schematic diagram of a building up of layers according to the prior art. In this example 8 layers 21-28 are deposited as shown in the upper part of FIG. 2A. The first 5 layers 21-25 comprise structure ink for the elevation. The layers 22-26 comprise ink 126 for anti-contouring. The layers 23-27 comprise white ink. The layers 24-28 comprise colored ink to form the image on top. Each layer 21-28 is deposited in 4 passes. In the example of FIG. 2A also a height difference is shown which has a slope starting with a triangular built up 30 of the last elevation layer for the pixels involved. The triangular built up 30 is shown in an enlarged way in the lower part of FIG. 2A. As shown the structure ink deposited in the last pass has a varying height, i.e. a different amount of ink is deposited in positions 31-35 in the last pass of the last elevation layer per position 31-35. A high amount of ink as for example at position 35 results in glossy appearance. A low amount of ink as for example in position 32 results in a matte appearance. The differences in glossiness characterize a well-known type of anti-contouring artefact.

FIG. 2B is a schematic diagram of a building up of layers according to the present invention. A number of 7 layers 21b-27b are deposited as shown in the upper part of FIG. 2B. The first 5 layers 21b-25b comprise structure ink for the elevation. The ink 126 for anti-contouring as shown in FIG. 2A is left out of the building up of the relief print. According to the present invention the anti-contouring ink 126 shown in FIG. 2A is no longer needed which results in a reduced number of 7 layers 21 b-27b.

In FIG. 2B the layers 22b-27b comprise white ink. The layers 23b-27b comprise colored ink to form the image on top. Each layer 21b-27b is deposited in 4 passes. In the example of FIG. 2B also a height difference is shown which has a slope starting with a triangular built up 50 of the last elevation layer for the pixels involved. The triangular built up 50 is shown in an enlarged way in the lower part of FIG. 2B. As shown the structure ink deposited in the last pass has a constant height, i.e. an equal amount of ink is deposited in positions 51-53 in the last pass of the last elevation layer per position 51-53. The equal amount of ink results in an equal gloss over the whole area of the slope and beyond. A gloss level may be adjusted with the amount of ink in the last pass. The passes before the last pass may be even empty at certain positions, i.e. no ink is jetted at certain positions.

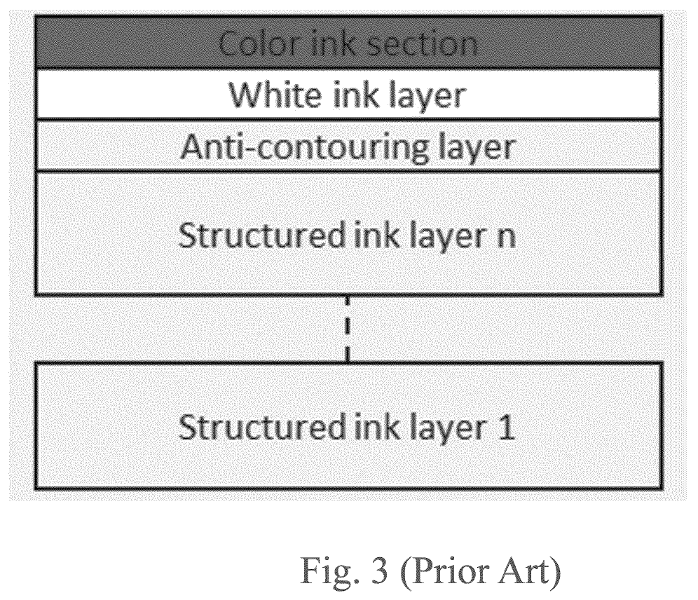

FIG. 3 is a schematic diagram of a building up of the layers according to the prior art which has been elucidated hereinbefore.

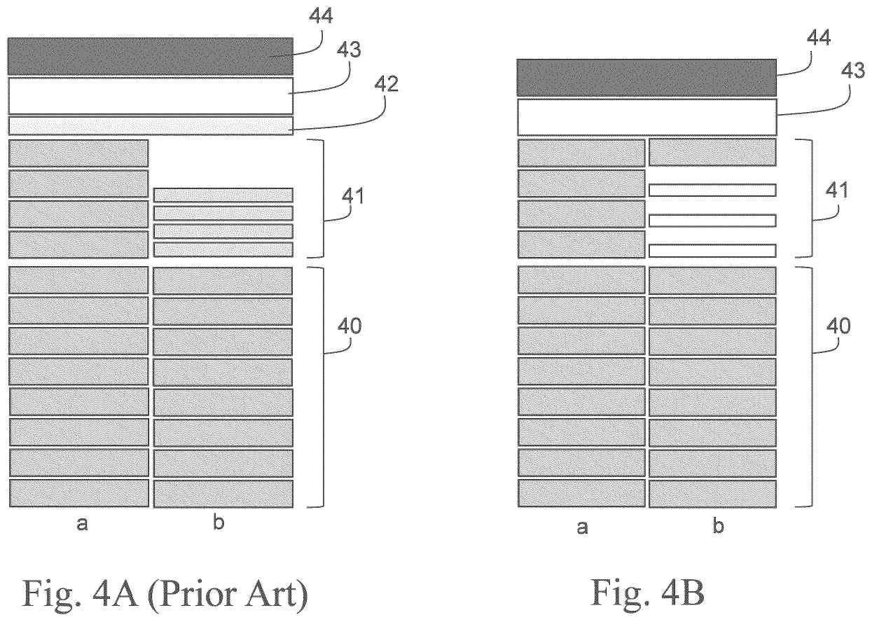

FIG. 4A is a schematic cross view of layers and passes according to the prior art. The color ink layer 44 is deposited on top of a white ink layer 43. The white ink layer is deposited on top of the anti-contouring layer 42. The anti-contouring layer is deposited on top of the last elevation layer 41. In this example the last elevation layer is built up in 4 passes. Each pass has for example a height of 8 μm at a coordinate a, while each pass in the last elevation layer 41 has for example a height of 2 μm at a coordinate b.

Coordinate a and coordinate b may be neighboring coordinates, for example neighboring pixels. However, coordinate a and coordinate b may also be envisioned as positions from different areas of the image to be printed. The total height of structure ink in the last elevation layer 41 at coordinate a is 32 μm, while the total height of structure ink in the last elevation layer 41 at coordinate b is 8 μm. When focusing on a top view (not shown) of the last elevation layer 41 a difference in gloss finish is present. At coordinate a the image has a glossy appearance. At coordinate b the image has a matte appearance. The last elevation layer 41 is built up after depositing at least one elevation layer 40 of for example 8 passes. In FIG. 4A only one such elevation layer 40 is shown for convenience reasons.

Resuming, in the prior art according to FIG. 4A areas with a maximum elevation in the last elevation layer will be printed with a high amount of structure ink per pass resulting in a glossy appearance and areas with a low elevation in the last elevation layer will be printed with a limited amount of ink per pass resulting in a matte appearance.

FIG. 4B is a schematic cross view of layers and passes according to an embodiment of the method according to the present invention. The color ink layer 44 is deposited on top of a white ink layer 43. The anti-contouring layer 42 as shown in FIG. 4A is left out.

The white ink layer is deposited on top of the last elevation layer 41. In this example the last elevation layer is built up in 4 passes. Each pass has for example a height of 8 μm at a coordinate a, while the first three passes in the last elevation layer 41 at coordinate b has for example a height of 0 μm, i.e. are empty. The last pass in the last elevation layer 41 at coordinate b has a height of 8 μm which is equal to the height of the last pass of the last elevation layer at coordinate a. The amount of ink deposited in the last pass of the last structure layer 41 is 8 μm at coordinate a as well as at coordinate b.

Coordinate a and coordinate b may be neighboring coordinates, for example neighboring pixels. However, coordinate a and coordinate b may also be envisioned as positions from different areas of the image to be printed. When focusing on a top view (not shown) of the last elevation layer 41 an equal gloss appearance, i.e. a constant gloss level, is present. In the example of FIG. 4B the height of 8 μm will result in a glossy appearance. If a more matte appearance is desired, the thickness of the last elevation layer may be lowered at position a as well as at position b. The last elevation layer 41 is built up after depositing at least one elevation layer 40 of for example 8 passes. In FIG. 4B only one such elevation layer 40 is shown for convenience reasons.

The print controller of the printer shown in FIG. 1 is configured to create a last in time elevation layer 41 intended to be printed in the predetermined plurality of passes, wherein the last in time elevation layer 41 is formed by droplets of structure ink having a fixed amount, i.e. a fixed coverage, per pixel in at least one last pass of the last in time elevation layer 41.

The amount of ink in at least the last pass of the last elevation layer 41 is constant which results in an equal gloss over the whole area. The passes before the last pass of the last elevation layer may contain a limited amount of structure ink or even be empty as shown in FIG. 4B.

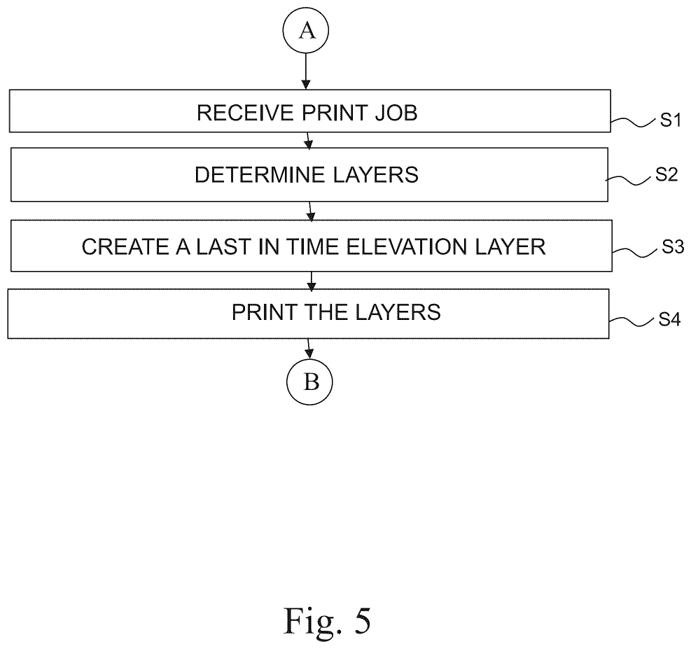

FIG. 5 is an example of a flow diagram of the method according to the embodiment of the present invention shown in FIG. 4B.

The method starts in a starting point A which leads to a first step S1.

In the first step S1 the print controller receives a print job comprising a color image with color information per pixel comprising a color per pixel which is intended to be achieved by depositing the colored ink, and a height image with height information per pixel comprising a height per pixel which is intended to be achieved by depositing a plurality of elevation layers of structure ink.

In a second step S2 the print controller determines besides the plurality of elevation layers at least one reflective layer of white ink and at least one colored layer of colored ink to form the color image.

In a third step S3 the print controller creates a last in time elevation layer intended to be printed in the predetermined plurality of passes, wherein the last in time elevation layer is formed by droplets of structure ink having a fixed coverage per pixel in at least one last pass of the last in time elevation layer.

In a fourth step S4 the print head assembly subsequently prints the plurality of elevation layers including the last in time elevation layer created in the third step S3, the at least one white layer and the at least one colored layer.

The method ends in an end point b.

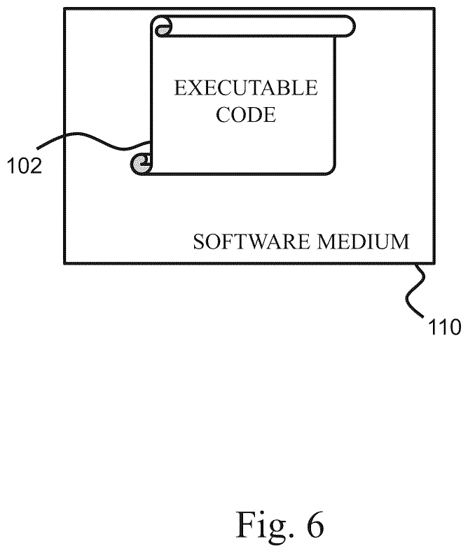

FIG. 6 schematically shows a non-transitory software medium 110 according to the invention. The software medium 110 comprises executable code 102 configured to, when executed, perform the method according to the invention, e.g. as described with respect to either the printer shown in FIG. 1 or the method shown in FIGS. 2B, 4B and 5 and/or according to any of the variants and modifications of the printer and/or of the method described herein before.

The non-transitory software medium 110 may, specifically, be formed as a CD or a CD-ROM, a DVD or a DVD-ROM, a BluRay disc or a BluRay-ROM disc, a magnetic hard drive, a solid state disk (SSD) hard drive, a USB memory device and so on.

The skilled person will recognize that other embodiments are possible within the scope of the appended claims.

Although specific embodiments of the invention are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for a UV curable printer comprising a medium support surface for supporting the print media, a print head assembly for ejecting droplets of structure ink, white ink and colored ink forming a relief print on the print media and a print controller for controlling the printing of the relief print in layers, each layer to be deposited in a predetermined plurality of passes of the print head assembly over the medium support surface, the method comprising the steps of
the print controller receiving a print job comprising a color image with color information per pixel comprising a color per pixel which is intended to be achieved by depositing the colored ink, and a height image with height information per pixel comprising a height per pixel which is intended to be achieved by depositing a plurality of elevation layers of structure ink,
the print controller determining besides the plurality of elevation layers at least one reflective layer of white ink and at least colored layer of colored ink to form the color image,
the print head assembly subsequently printing the plurality of elevation layers, the at least one white layer and the at least one colored layer, wherein the method comprises the steps of
the print controller creating a last in time elevation layer intended to be printed in the predetermined plurality of passes, wherein the last in time elevation layer is formed by droplets of structure ink having a fixed coverage per pixel in at least one last pass of the last in time elevation layer.

2. Method according to claim 1, wherein the method is applied to the last in time elevation layer and the one layer before the last in time elevation layer to be deposited.

3. Method according to claim 1, wherein the method comprises the steps of the print controller receiving the print job comprising a gloss image with gloss information per pixel of the color image, and the print head assembly depositing varnish ink on top of the colored ink in accordance with the gloss image.

4. A UV curable printer comprising a medium support surface for supporting print media to be printed upon, a print head assembly for ejecting color inks, white ink, structure ink forming a relief print on the print media and a print controller for controlling the printing of a color image on the print media in multiple layers as to form the relief print, wherein the print controller is configured to perform the steps of a method according to claim 1.

5. A UV curable printer according to claim 4, wherein the print head assembly is configured to deposit varnish ink on top of deposited colored ink.

6. A non-transitory software medium comprising executable program code configured to, when executed on a print controller of a UV curable printer, enable the print controller to perform the steps of the method according to claim 1.
